(19) United States
(12) Patent Application Publication
(10) Pub. No.: US 2006/0136663 A1
(43) Pub. Date: Jun. 22, 2006

(54) Sector-specific access control

(76) Inventors: Robert Alan Cochran, Sacramento, CA (US); Marcel Duvekot, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/017,705

(22) Filed: Dec. 22, 2004

(51) Int. Cl. G06F 12/00

(52) U.S. Cl. 711/112

(57) ABSTRACT

A method, of controlling access to storage locations on a hard-disk-based memory device, may include: receiving an input/output (I/O) request for access to the memory device; evaluating the I/O request in terms of one or more sectors on the hard-disk-based memory device comprehended by the I/O request; and selectively granting the I/O request on a sector-specific basis.

### BACKGROUND OF THE PRESENT INVENTION

The Securities and Exchange Commission (SEC) mandates that broker-dealers preserve a wide range of records which may be stored in electronic form. The SEC defines strict requirements for storage of these electronic records as detailed in Rule 17a-4. More particularly, Rule 17a-4 requires that a digital storage media or system must preserve the records exclusively in a non-rewritable, non-erasable format.

Originally, Write-Once-Read-Many (WORM) optical disks provided the only available technology to meet the non-rewritable, non-erasable requirement of Rule 17a-4. More recently, disk array manufacturers have offered Access-Control functionality that is granular down only to the logical unit (LU) level.

### SUMMARY OF THE PRESENT INVENTION

At least one other embodiment of the present invention provides a method of controlling access to storage locations on a hard-disk-based memory device. Such a method may include: receiving an input/output (I/O) request for access to the memory device; evaluating the I/O request in terms of one or more sectors on the hard-disk-based memory device comprehended by the I/O request; and selectively granting the I/O request on a sector-specific basis.

Additional features and advantages of the present invention will be more fully apparent from the following detailed description of example embodiments, the accompanying drawings and the associated claims.

### BRIEF DESCRIPTION OF THE DRAWINGS

The drawings are: intended to depict example embodiments of the present invention and should not be interpreted to limit the scope thereof. In particular, relative sizes of the components of a figure may be reduced or exaggerated for clarity. In other words, the figures are not drawn to scale.

FIG. 1 is a hardware block diagram according to an embodiment of the present invention.

FIGS. 2A-2D are tables illustrating data relationships in a machine-actionable memory that represents sector-specific access-control characteristics, according to at least one embodiment of the present invention.

FIG. 3 is a flowchart depicting a method of sector-level control of access to storage locations on a hard-disk-based memory device, according to at least one embodiment of the present invention.

### DETAILED DESCRIPTION OF EXAMPLE EMBODIMENTS

In developing the present invention, the following problems with the Background Art were recognized and a path to a solution identified. Access-Control functionality that is granular down only to the logical unit (again, LU) level is inconsistent with typical usage of an LU. Such granularity is, in effect, an all-or-nothing approach to writing to the LU. Rarely does a user write an entire LU such that an immediate subsequent prevention of further writing to the entire LU would not be substantially wasteful. Instead, a user typically writes (and so fills up) an LU in a piecemeal fashion. The Background Art's all-or-nothing approach to LU-granularity access control is wasteful of resources or burdens the user to batch together an amount of writes sufficient to substantially consume the LU, both of which are problems.

A simplistic solution would be to greatly reduce the typical LU size to match the typical size of a write. But such micro-LUs would negate many of the benefits of typically-sized LUs, and would require developing some sort of macro-LU by which operations could by conducted on the totality of storage allocated to a user. Instead, it would be beneficial to impose write-once-type access control at the sector level for hard-disk-based memory (or, in other words, disk array) devices. At least one embodiment of the present invention can provide such sector-specific write-once-type access control.

Some embodiments of the present invention will now be discussed.

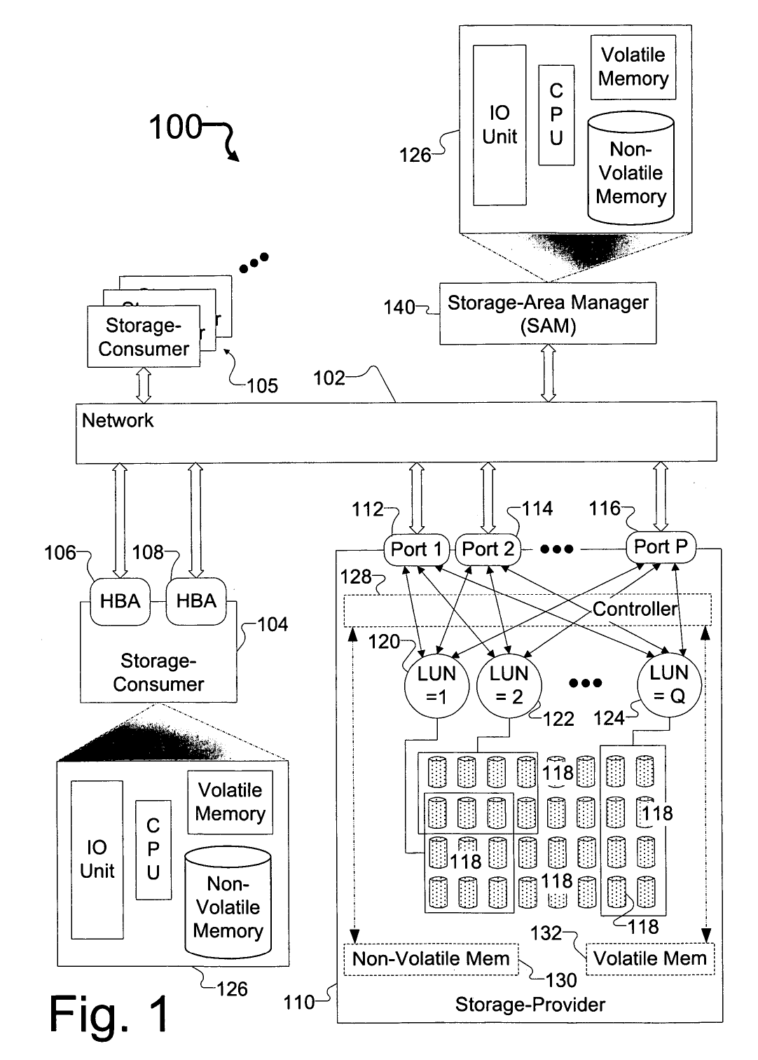

FIG. 1 depicts a hardware block diagram of a storage area network (SAN) 100 that can use a method according to an embodiment of the present invention, making system 100 itself an embodiment of the present invention.

System 100 includes a network (e.g., SCSI, Ethernet (iSCSI/IP/Gbit Ethernet), Fibre Channel, etc.) 102 to which are connected consumers 104 and 105 (hereafter storage-consumer devices) of services, e.g., storage services; a storage-provider device 110; and a storage area manager (SAM) 140.

Storage-consumer 104 includes host bus adapters (HBAs) 106 and 108 that permit storage consumer 104 to connect to and interact with network 102. Device 110 can be described as a hard-disk-based device. Device 110 has port 1 (112), port 2 (114), . . . port P (116). For simplicity of disclosure, only two HBAs 106 and 108 have been depicted, but fewer (1) or more HBAs could be present in storage-consumer device 110 depending upon the particular circumstances of a situation. Optional storage-consumer devices 105 are similar to storage-provider device 110.

Storage-consumer devices 104/105 and/or SAM 140 can take the form of a computer 126 including at least a CPU, input device(s), output device(s) and memory. For example, in exploded views, computer 126 has been depicted as including a CPU, an IO device, volatile memory such as RAM and non-volatile memory such as ROM, flash memory, disc drives and/or tape drives.

SAM 140 is a tool by which a storage administrator can manage the environment of SAN 100. SAM 140 can be used to control and monitor the health of all the components within SAN 100, including tape-based and hard-disk-based storage, servers, switches, etc., as well as any directly attached storage.

Storage-provider device 110 further includes hard-disk drives 118. A logical unit (LU) is a mapping to at least portions of one or more of hard-disk drives 118. To remind the reader of that logical nature of an LU, a simplistic mapping between LU numbers (LUNs) 1,2, . . . , Q (namely LUN=1 having Ref. No. 120, LUN=2 having Ref. No. 122 and LUN=Q having Ref. No. 124) and hard-disk drives 118 has been illustrated in FIG. 1. An LU containing R addressable logical sectors (hereafter, LU sectors) can physically reside on all or part of any number, X, of hard-disk drives 118, respectively, where 1≦X≦R and X and R are positive integers. Typically, for example, an LU resides on all or part of between 2 and 8 hard-disk drives 118, respectively.

Storage-provider device 110 yet further includes a controller 128, non-volatile memory 130, e.g., firm-ware, and volatile memory 132. As FIG. 1 is primarily a logical diagram, controller 128 and memories 130 & 132 have been drawn with phantom lines. More particularly, communication paths between ports 112-116 and LUs 120-124 have been drawn as passing though controller 128 to convey that the access which such paths respectively represent is controlled by controller 128.

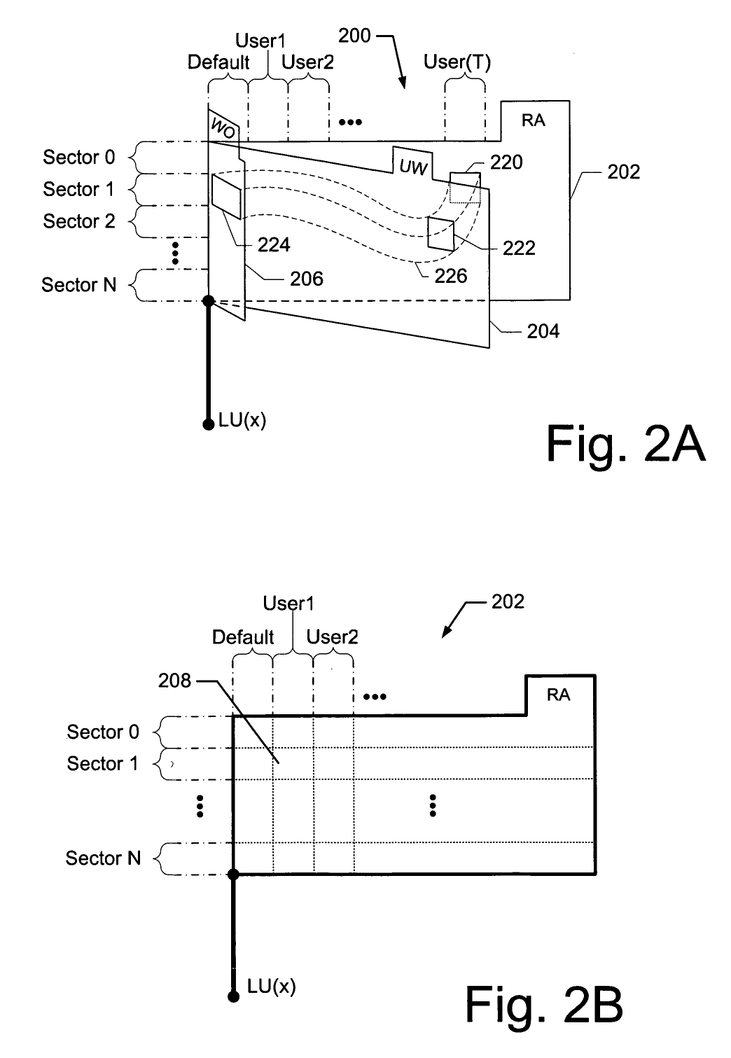

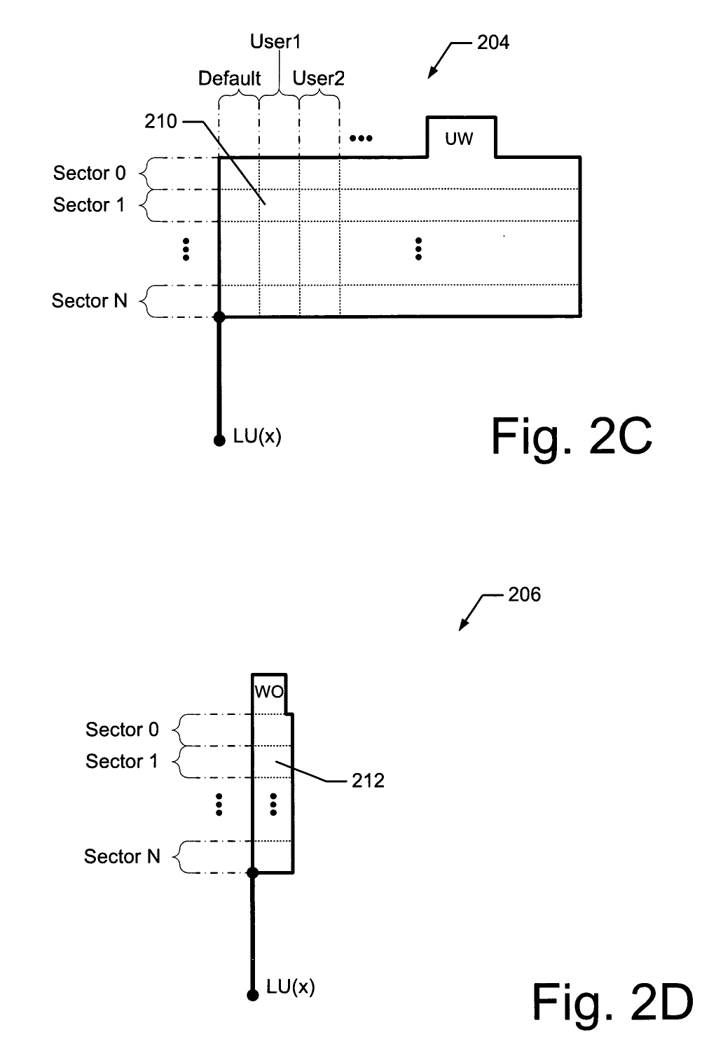

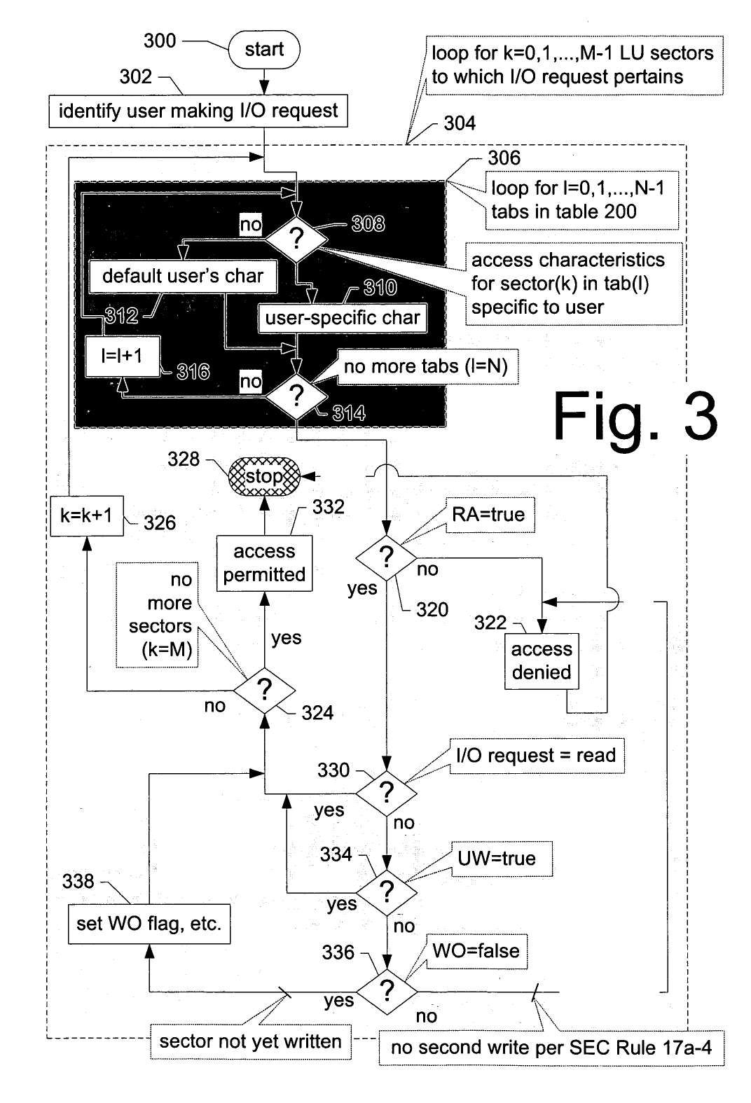

Stored within, e.g., volatile memory 132 (and/or, optionally, non-volatile 130) are machine-actionable records arranged according to a data structure. There can be, e.g., such a machine-actionable record for each LU sector residing on hard-disk drives 118 of storage-provider 110. Example representations of such records are depicted in FIGS. 2A-2D (to be discussed in more detail below). Controller 128 can selectively grant an input/output (I/O) request, for access to one or more LU sectors on hard-disk drives 118, according to these records (as will be discussed below).

FIGS. 2A-2D are tables illustrating data relationships in a machine-actionable memory that represents sector-specific access-control characteristics, according to at least one embodiment of the present invention.

More particularly, in FIG. 2A, a table 200 illustrates data relationships representing sector-specific access-control characteristics for LU sectors on hard-disk drives 118, respectively of storage-provider 110. Table 200 can be described as including three tabs, namely an at-least-read-access (RA) tab 202, an unlimited-write (UW) tab 204, and a write-once (WO) tab 206. To simplify illustration, FIG. 2A (and, for that matter, FIGS. 2B-2D) assume a given LU(x). Typically, table 200 would be an M-dimensional array (where M is a positive integer) to accommodate the varying number of LUs.

Each of RA tab 202 and UW tab 204 can include: rows corresponding to individual LU sectors; and columns corresponding to individual users, where one of the columns can represent the default user. Each row can be associated (or, in other words, linked) with a field in which is stored an identification (ID) of the LU sector. Each column can be associated (or, in other words, linked) with a field in which is stored an identification (ID) of the user. WO tab 206 is similar in that it includes rows corresponding to LU sectors, but differs in that there should be only one column because the WO characteristic should not be user-dependent.

Controller 128 can, for example, associate a given LU sector on LU(x) with a given physical sector on a given one of hard-disk drives 118, a given platter on the given hard-disk drive 118, a given side of the given hard-disk drive 118, and a given track of the given platter. Such an association can be made, e.g., in a machine-actionable memory arrangement separate from table 200.

FIG. 2B depicts RA tab 202 of table 200 in more detail. An entry(i,j) at the intersection of the i^{th} row and the j^{th} column (called out with Ref. No. 208) in RA tab 202 represents an RA (again, at-least-read-access) field. The contents of each entry(i,j) 208 can be indicative of whether the RA characteristic has been designated for the corresponding LU sector. Each entry(i,j) 208 can be described as being similar to, or the same as, a flag.

An example is given of how the RA characteristic might be used. Suppose that confidential data (e.g., personnel information, sales figures, etc.) is stored in the sector to which the i^{th} row corresponds. And further suppose that only selected individuals are given read-access or greater to the sector. The default value for the i^{th} row could be set to FALSE (meaning not even read-access permitted). For selected other users, however, the RA characteristic could be set to TRUE (meaning at least read-access is permitted).

FIG. 2C depicts UW tab 204 of table 200 in more detail. An entry(i,j) at the intersection of the i^{th} row and the j^{th} column (called out with Ref. No. 210) in UW tab 204 represents a UW (again, unlimited-write) field. The contents of each entry(i,j) 210 can be indicative of whether the UW characteristic has been designated for the corresponding LU sector. Each entry(i,j) 210 can be described as being similar to, or the same as, a flag.

FIG. 2D depicts WO tab 206 of table 200 in more detail. An entry(i) for the i^{th} row of the sole (called out with Ref. No. 212) in WO tab 206 represents a WO (again, write-once) field. The contents of each entry(i) 210 can be indicative of whether a write has already been made to the corresponding LU sector & user combination. Each entry(i) 212 can be described as being similar to, or the same as, a flag.

It should be understood that corresponding flags, e.g., 220, 222 and 224 for user(T) in tabs 202, 204 and 206, respectively, can alternatively be described as bits in a word or field 226, e.g., having 3 bits. In that description, table 200 could be described as a single-tab type of table having a word/field 226 for each user as well as for a default user. As there is only one column in tab 206, each word/field for a given sector would commonly use the same flag 224, whereas the flags 220 and 222 could differ.

A single-tab type of table having words/fields 226, or the combination of flags 220, 222 and 224 in a three-tab type of table, could be subject to an errant setting of values for the three flags 202, 204 and 206 by, e.g., an administrator, that results in an inconsistent combination. For example, an inconsistent combination could be WO=TRUE and UW=TRUE. A simple Boolean check can be used to verify that no inconsistent combinations of values are stored. Examples of consistent and inconsistent combinations are given in the following table.

| WO | UW | RA | Consistent | Inconsistent |
|---|---|---|---|---|
| FALSE | FALSE | FALSE | ✓ | |
| FALSE | FALSE | TRUE | ✓ | |
| FALSE | TRUE | FALSE | | ✓ |
| FALSE | TRUE | TRUE | ✓ | |
| TRUE | FALSE | FALSE | ✓ | |
| TRUE | FALSE | TRUE | ✓ | |
| TRUE | TRUE | FALSE | | ✓ |
| TRUE | TRUE | TRUE | | ✓ |

FIG. 3 is a flowchart depicting a method of sector-level control of access to storage locations on a hard-disk-based memory device, according to at least one embodiment of the present invention.

The method of FIG. 3 can be performed by, e.g., controller 128 of storage-provider 110. For example, controller 128 can intercept I/O requests and evaluate whether they should be granted in terms of the LU sectors for which access is sought and characteristics for those LU sectors represented in one or more tables 200 in non-volatile memory 130 and/or volatile memory 132.

Flow starts in FIG. 3 at block 300 and proceeds to block 302, where the user (who has made the intercepted I/O request) is identified. Flow proceeds from block 302 into a loop, called out as Ref. No. 304. An I/O request can pertain to one or more LU sectors. Loop 304 is iterated once for each of the LU sectors k=0,1, . . . , M−1 (where M is a positive integer) to which the I/O request pertains.

Within loop 304, flow proceeds initially into a nested loop, called out as Ref. No. 306. An LU sector's access characteristics can be stored in one or more tabs of table 200. Loop 306 is iterated once for each of the tabs I=0,1, . . . , N−1 (where N is a positive integer) in table 200. Within loop 306, flow proceeds to decision block 308, where it is determined whether there is a user-specific access characteristic in tab(I) for sector(k). If so, then flow proceeds to block 310, where the user-specific sector characteristic for tab(I) can be gathered. But if not (i.e., there is no user-specific characteristic for tab(I)), then flow proceeds out of decision block 308 to block 312, where the default user's characteristic for tab(I) can be gathered.

For example, controller 128 can index into table 200 in non-volatile memory 130 using the user's ID to obtain any entries(i,j) in tabs 202 and 204 specific to the user, and can store a copy of such entries/flags in non-volatile memory 130 or volatile memory 132. If there is no user-specific entry/flag in any of tabs 202 and 204, then controller 128 can store a copy of the corresponding default entries/flags in volatile memory 132, respectively.

Flow proceeds from each of blocks 312 and 310 to decision block 314, where it is determined if there are no other tabs yet to be checked, e.g., by determining if I=N. If not (e.g., I<N), then flow proceeds to block 316, where I is incremented (e.g., I=I+1). From block 316, flow loops back to start another iteration of loop 306 at decision block 308. But if there are no other tabs yet to be checked, then flow exits loop 306 and proceeds to decision block 320.

At decision block 320, it is determined whether the RA characteristic has been designated for sector(k). If the contents of the RA field/flag=FALSE, then flow proceeds to block 322, where the I/O request is denied. More particularly, the request can be denied for all of the LU sectors to which the I/O request pertains. From block 322, flow can proceed to stop block 328. This can be described as a request-level decision (albeit determined on a sector-level basis) as contrasted with a sector-level decision (to be discussed below).

If it is determined at decision block 320 that the RA field/flag=TRUE, then flow proceeds to decision block 330. It is determined at decision block 330 whether the I/O request is a read request. If so (i.e., the I/O request is a read request), then flow proceeds to decision block 324.

At decision block 324, it is determined whether there are no other LU sectors yet to be evaluated, e.g., by determining if k=M. If k<M, then flow proceeds to block 326, where k is incremented (e.g., k=k+1). From block 316, flow loops back to start another iteration of loop 306 at decision block 308. From block 326, flow loops back to start another iteration of loop 304 at decision block 308.

If, however, it is determined at decision block 324 that k=M, then flow proceeds to block 332, where the requested I/O access is permitted. More particularly, the request is permitted for all of the LU sectors to which the I/O request pertains. Under the request-level decision scheme, access is permitted only after the I/O requested is evaluated in terms of the sector-specific characteristics for all of the LU sectors to which the I/O request pertains. Such a scheme can avoid data corruption that could result, e.g., if write access was permitted to one but not all of the LU sectors to which the I/O request pertains.

Returning to decision block 330, if it is determined that the I/O request is not a read request, then flow can proceed to decision block 334. At decision block 334, it is determined whether the UW characteristic has been designated for sector(k). If the contents of the UW field/flag=TRUE, then flow can proceed to decision block 324 (described above), where (again) it is determined if there are other LU sectors yet to be evaluated. But if it is determined at decision block 334 that the UW field/flag=FALSE, then flow proceeds to decision block 336.

At decision block 336, it is determined whether the contents of the WO field/flag for sector(k) indicate that a write has not yet been made to sector(k), e.g., whether WO field/flag=FALSE. If the UW field/flag=FALSE (meaning not yet written into), then flow proceeds to block 338, where W/O field/flag for sector(k) can be set to indicate that the field has been written into. Also at block 338, resultant inconsistencies (e.g., WO=TRUE) can be correspondingly corrected (e.g., set WO=FALSE). From block 338, flow can proceed to decision block 324 (described above), where (again) it is determined if there are other LU sectors yet to be evaluated.

But if it is determined at decision block 336 that the WO field/flag=TRUE (meaning that sector(k) has been written into once), then flow proceeds to block 322 (described above), where access to sector(k) is denied. When block 322 is reached from decision block 336, this reflects the requirement of SEC Rule 17a-4. Here, that can be understood as preventing a no second write to sector(k).

Alternatively, rather than using a request-level decision scheme, a sector-level decision could be used. A sector-level decision scheme can permit write access to a given LU sector comprehended by an I/O request regardless of whether access has been or will be denied to any other LU sectors comprehended by the same I/O request. As noted above, a sector-level decision scheme could be susceptible to data corruption where a write is permitted to less than all of the LU sectors to which the I/O request pertains.

The methodologies discussed above can be embodied on a machine-readable medium. Such a machine-readable medium can include code segments embodied thereon that, when read by a machine, cause the machine to perform the methodologies described above.

Of course, although several variances and example embodiments of the present invention are discussed herein, it is readily understood by those of ordinary skill in the art that various additional modifications may also be made to the present invention. Accordingly, the example embodiments discussed herein are not limiting of the present invention.

What is claimed:

1. A method of controlling access to storage locations on a hard-disk-based memory device, the method comprising:
receiving an input/output (I/O) request for access to the memory device;
evaluating the I/O request in terms of one or more sectors on the hard-disk-based memory device comprehended by the I/O request; and
selectively granting the I/O request on a sector-specific basis.

2. The method of claim 1, wherein the selectively granting includes at least one of the following:
denying the request based upon access-criteria specific to the one or more sectors, respectively; and
denying the request based upon access-criteria specific to the user who has made the request.

3. The method of claim 1, wherein the selectively granting, for a given sector, includes:
determining, if an at-least-read-access (RA) characteristic has been designated.

4. The method of claim 3, wherein the selective granting of the request, for the given sector, further includes:
granting, where the RA-characteristic has been designated, the I/O request if the I/O request is for a read.

5. The method of claim 3, wherein the selective granting of the request, for the given sector, further includes:
determining, where the RA-characteristic has been designated, if an unlimited-write (UW) characteristic has been designated.

6. The method of claim 5, wherein the selective granting of the request, for the given sector, further includes:
determining, if the UW-characteristic has not been designated, if a written-once (WO) flag has been set.

7. The method of claim 6, wherein the selective granting of the request, for the given sector where the WO-flag has not been set, further includes:
granting the I/O request; and then
setting the WO-flag.

8. The method of claim 1, the selectively granting includes:
determining, if there are access characteristics specific to the user who has made the request;
evaluating, if so, the I/O request according to the user-specific access characteristics; and
else evaluating the I/O request according to default access characteristics.

9. The method of claim 1, wherein the one or more sectors are logical sectors included within a logical unit residing on the hard-disk-based memory device.

10. A machine-actionable memory comprising:
a plurality of machine-actionable records respectively arranged according to a data structure, the plurality of machine-actionable records representing a plurality of sectors on a hard-disk-based memory device, the data structure including the following linked fields:
a sector_ID field, the contents of which are indicative of an identification (ID) of a sector; and
a WO flag, the contents of which are indicative of a written-once (WO) status of the sector indicative of whether a write has already been made to the sector.

11. The machine-actionable memory of claim 10, wherein the data structure further includes at least one of the following linked fields:
an RA field, the contents of which are indicative of whether an at-least-read-access (RA) characteristic has been designated for the sector; and
a UW field, the contents of which are indicative of whether an unlimited write (UW) characteristic has been designated for the sector.

12. The machine-actionable memory of claim 11, wherein the data structure further includes both of the RA field and the UW field.

13. The machine-actionable memory of claim 11, wherein the sectors are logical sectors included within a logical unit residing on the hard-disk-based memory device.

14. A machine configured to implement the method of claim 1.

15. An apparatus for controlling access to storage locations on a hard-disk-based memory device, the apparatus comprising:
a machine-actionable memory including a plurality of machine-actionable records corresponding to a plurality of sectors on the hard-disk-based memory device, each machine-actionable record respectively being arranged according to a data structure, the data structure including the following linked fields,
a sector_ID field, the contents of which are indicative of an identification (ID) of a sector, and
at least a first access-restriction field and a second access restriction field, the second access-restriction field indicating a more restrictive type of access to the sector than is indicated by the first access-restriction field; and
a controller to selectively grant an input/output (I/O) request, for access to one or more sectors on the hard-disk-based memory device, according to the one or more data structures corresponding to the one or more sectors comprehended by the I/O request.

16. The apparatus of claim 15, wherein the data structure further includes at least one of the following linked fields:
an RA field, the contents of which are indicative of whether an at-least-read-access (RA) characteristic has been designated for the sector; and
a UW field, the contents of which are indicative of whether an unlimited write (UW) characteristic has been designated for the sector.

17. The apparatus of claim 15, wherein the sectors are logical sectors included within a logical unit residing on the hard-disk-based memory device.

18. An apparatus for controlling access to storage locations on a hard-disk-based memory device, the apparatus comprising:
means for receiving and evaluating an input/output (I/O) request in terms of one or more sectors on the hard-disk-based memory device comprehended by the I/O request; and
means for selectively granting the I/O request on a per-sector basis.

19. A machine-readable medium comprising instructions, execution of which by a machine controls access to storage locations on a hard-disk-based memory device, the machine-readable instructions comprising:
a first code segment to receive an input/output (I/O) request for access to the memory device;
a second code segment to evaluate the I/O request in terms of one or more sectors on the hard-disk-based memory device comprehended by the I/O request; and
a third code segment to selectively grant the I/O request on a per-sector basis.

20. The machine-readable instructions of claim 19, wherein execution of the third code segment further renders the machine operable to deny the request based upon access-criteria specific to the one or more sectors, respectively; and
deny the request based upon access-criteria specific to the user who has made the request.

21. The machine-readable instructions of claim 19, wherein execution of the second code segment further renders the machine, for a given segment, operable to:
determine, if an at-least-read-access (RA) characteristic has been designated.

22. The machine-readable instructions of claim 21, wherein execution of the third code segment further renders the machine, for the given segment, operable to:
grant, where the RA-characteristic has been designated, the I/O request if the I/O request is for a read.

23. The machine-readable instructions of claim 21, wherein execution of the second code segment further renders the machine, for the given segment, operable to:
determine, where the RA-characteristic has been designated, if an unlimited-write (UW) characteristic has been designated.

24. The machine-readable instructions of claim 23, wherein execution of the second code segment further renders the machine operable, for the given segment, to:
determine, if the UW-characteristic has not been designated, if a written-once (WO) flag has been set.

25. The machine-readable instructions of claim 24, wherein execution of the third code segment further renders the machine, for the given segment where the WO-flag has not been set, operable to:
grant, the I/O request; and then
set the WO-flag.

26. The machine-readable instructions of claim 19, wherein execution of the first code segment further renders the machine operable to:
determine if there are access characteristics specific to the user who has made the request;
evaluate, if so, the I/O request according to the user-specific access characteristics; and
else evaluate the I/O request according to default access characteristics.

27. The machine-readable instructions of claim 19, wherein the sectors are logical sectors included within a logical unit residing on the hard-disk-based memory device.
